(19) United States
(12) Patent Application Publication
(10) Pub. No.: US 2025/0289300 A1
(43) Pub. Date: Sep. 18, 2025

(54) ELECTRIC DRIVE SYSTEM FOR A MOTOR VEHICLE, AND A METHOD FOR OPERATING SUCH AN ELECTRIC DRIVE SYSTEM

(71) Applicant: MERCEDES-BENZ GROUP AG, Stuttgart (DE)

(72) Inventors: Peter HAHN, Stuttgart (DE); Jonathan ZEIBIG, Aalen (DE); Carsten GITT, Stuttgart (DE); Tobias HAERTER, Stuttgart (DE); Tobias SCHILDER, Ludwigsburg (DE)

(21) Appl. No.: 18/859,649

(22) PCT Filed: Mar. 24, 2023
(86) PCT No.: PCT/EP2023/057728

§ 371 Date: Oct. 24, 2024

(30) Foreign Application Priority Data
Apr. 25, 2022 (DE) 10 2022 001 409.2

(51) Int. Cl. B60K 1/02; B60K 17/16; B60L 15/20

(52) U.S. Cl. CPC B60K 1/02; B60K 17/16; B60L 15/20

(57) ABSTRACT

An electric drive system for a motor vehicle includes a first electric engine and a second electric engine. A coupling gear mechanism has two output drive shafts configured to discharge output drive torques from the coupling gear mechanism. A first planetary gear set has a first element, a second element, and a third element connected in a rotationally fixed manner to a first of the output drive shafts. A second planetary gear set has a fourth element, a fifth element connected in a rotationally fixed manner to the second element, and a sixth element connected in a rotationally fixed manner to the second output drive shaft.

### BACKGROUND AND SUMMARY OF THE INVENTION

Exemplary embodiments of the invention relate to an electric drive system for a motor vehicle, in particular for a motor car, as well as to a method for operating such an electric drive system.

A power unit for driving two driven parts in order to drive a vehicle is known from U.S. Pat. No. 9,494,218 B2.

Exemplary embodiments of the present invention are directed to an electric drive system and a method for operating such an electric drive system, so that a particularly efficient operation and a particularly low installation space requirement of the drive system can be realized.

A first aspect of the invention relates to an electric drive system, also referred to as an electric drive device or designed as an electric drive device, for a motor vehicle, in particular for a motor car and more particularly for a passenger car. This means that, in its completely produced state, the motor vehicle has the electric drive system and can be driven electrically, in particular purely electrically, by means of the electric drive system. For example, the motor vehicle, in its completely produced state, has at least or exactly two axles, also referred to as vehicle axles, arranged successively and thus one behind the other in the vehicle longitudinal direction. The respective axle of the motor vehicle, also referred to as a vehicle, has at least or exactly two vehicle wheels, also referred to as wheels, and the vehicle wheels of the respective axle are arranged for example on opposite sides of the motor vehicle to each other in the vehicle transverse direction. For example, the vehicle wheels of at least one of the axles or both axles can be driven by means of the electric drive system, whereby the motor vehicle as a whole can be driven. The vehicle wheels that can be driven by means of the electric drive system are also referred to as drivable wheels or driven wheels. When the vehicle wheels or wheels are referred to in the following, unless otherwise stated, this means the vehicle wheels that can be driven by means of the electric drive system.

The electric drive system has a first electric engine, which has a first rotor. For example, the first electric engine has a first stator, by means of which, for example, the first rotor can be driven and as a result can be rotated around a first engine rotational axis, relative to the first rotor. In particular, the first electric engine can provide first drive torques via the first rotor for driving the vehicle wheels and thus the motor vehicle. Furthermore, the electric drive system has a second electric engine with a second rotor. In particular, the second electric engine has a second stator, by means of which, for example, the second rotor can be driven and as a result can be rotated around a second engine rotational axis, relative to the second stator. In particular, the second electric engine can provide second drive torques via its second rotor, by means of which the vehicle wheels and thus the vehicle can be driven. For example, the engine rotational axes extend parallel to each other. In particular, the engine rotational axes coincide, so that the electric engines can be arranged coaxially to each other, for example.

Furthermore, the electric drive system has a coupling gear mechanism, which has two output drive shafts, specifically a first output drive shaft and a second output drive shaft. The output drive shafts are designed to discharge output drive torques from the coupling gear mechanism. Expressed again in other words, the coupling gear mechanism can provide the output drive torques via its output drive shafts. Thus, for example, the first output drive shaft is designed to discharge the first of the output drive torques from the coupling gear mechanism, while the second output drive shaft is designed to discharge the second of the output drive torques from the coupling gear mechanism. For example, the respective first output drive torque and/or the respective second output drive torque result from the respective first drive torque and/or from the second drive torque.

The coupling gear mechanism has a first planetary gear set having a first element, a second element, and a third element. The third element is coupled, i.e., connected, in particular permanently, in a rotationally fixed manner to a first of the output drive shafts. The coupling gear mechanism also has a second planetary gear set having a fourth element, a fifth element, and a sixth element. The fifth element is connected, in particular permanently, in a rotationally fixed manner to the second element. The sixth element is connected, in particular permanently, in a rotationally fixed manner to the second output drive shaft.

The first element, the second element, and the third element are gear elements of the first planetary gear set or are also referred to as gear elements of the first planetary gear set. Preferably, one of the gear elements is designed as a first sun gear, a second of the gear elements is designed as a first planetary carrier, and a third of the gear elements is designed as a first ring gear of the first planetary gear set. The fourth element, the fifth element, and the sixth element are gear elements of the second planetary gear set. Preferably, one of the gear elements of the second planetary gear set is designed as a second sun gear, a second of the gear elements of the second planetary gear set is designed as a second planetary carrier, and a third of the gear elements is designed as a second ring gear of the second planetary gear set. The planetary carriers are also referred to as bridges. For example, the drive system has a housing, wherein the first planetary gear set and/or the second planetary gear set are each arranged at least partially in the housing. Particularly if the respective gear element is not connected to the housing in a rotationally fixed manner, for example the respective gear element can be rotated around a first planetary gear set rotational axis, relative to the housing. It is advantageous if the planetary gear sets are arranged coaxially to each other so that preferably the planetary gear set rotational axes coincide.

The respective planetary gear set rotational axis extends, for example, parallel to the respective engine rotational axis. Particularly advantageously, the respective planetary gear set rotational axis coincides with the respective engine rotational axis. Particularly advantageously, the two mentioned rotors and also the two planetary gear sets are all arranged coaxially to each other.

In the context of the present disclosure, the feature that two components, such as the first output drive shaft and the third element or the second output drive shaft and the sixth element, are connected to each other in a rotationally fixed manner is to be understood as meaning that the components connected to each other in a rotationally fixed manner are arranged coaxially to each other and, in particular when the components are driven, rotate together or simultaneously at the same angular velocity around a component rotational axis common to the components, such as for example the first or second planetary gear set rotational axis, in particular relative to the housing.

The feature that two components are connected to each other in a torque-transmitting manner means that the components are coupled or connected to each other in such a way that torques can be transmitted between the components, and if the components are connected to each other in a rotationally fixed manner, the components are also connected to each other in a torque-transmitting manner. The feature that two components are permanently connected to each other in a torque-transmitting manner means that rather than a switching element for instance being provided, which can be switched between a coupled state connecting the components to each other in a torque-transmitting manner and a decoupled state in which no torques can be transmitted between the components, instead the components are constantly or always and thus permanently connected to each other in a torque-transmitting manner, i.e., in such a way that a torque can be transmitted between the components. This means, for example, that one of the components can be driven by the respective other component and vice versa.

In particular, the feature that two components are permanently connected to each other in a rotationally fixed manner means that rather than a switching element, for instance, being provided that can be switched between a coupled state connecting the components to each other in a rotationally fixed manner and a decoupled state in which the components are decoupled from each other and rotatable relative to each other, in particular about the component rotational axis, so that no torques can be transmitted between the components, instead the components are constantly or always, i.e., permanently, connected or coupled to each other in a rotationally fixed manner. In other words, the term “rotationally fixed manner” means that two elements are connected to each other in a rotationally fixed manner if they are arranged coaxially to each other and are connected to each other in such a way that they rotate at the same angular velocity, in particular around the component rotational axis.

In the electric drive system for the motor vehicle, again in a known manner, a first vehicle wheel and a second vehicle wheel are provided, via which contact can be made by the electric drive system or the motor vehicle with a road surface. In this case, the first output drive shaft is or can be coupled in a torque-transmitting manner to the first vehicle wheel, bypassing the second element. And the second output drive shaft is or can be coupled in a torque-transmitting manner to the second vehicle wheel, bypassing the second element. The two output drive shafts are thus arranged downstream of the second element, with respect to a torque flow originating from the electric engines. Advantageously, the two output drive shafts are also arranged downstream of the first element and downstream of the fourth element. In this respect, the first vehicle wheel is arranged downstream of the first output drive shaft, and the second vehicle wheel is arranged downstream of the second output drive shaft.

It is likewise already known from the cited prior art that second planetary gears are rotatably mounted on the second element, the second planetary gears meshing permanently with a third toothing of the third element.

According to the invention, the second planetary gears and third planetary gears are rotatably mounted on the fifth element, wherein in each case one of the second planetary gears meshes with one of the third planetary gears, wherein the second planetary gears are arranged both axially overlapping the third element as well as axially overlapping the fourth element. In this manner, in comparison to the mentioned prior art, a toothing plane can be omitted in the coupling gear mechanism, whereby the installation space requirement can be reduced, in particular in an axial direction.

Thus, according to the invention, it is also provided that the second element is the first planetary carrier, and the fifth element is the second planetary carrier.

The axial direction refers to the direction of a main rotational axis of the coupling gear mechanism. The main rotational axis of the coupling gear mechanism refers to the rotational axis of the elements (sun gears, planetary carriers, ring gears) of the coupling gear mechanism.

A development of the invention provides that the third planetary gears mesh permanently with a sixth toothing of the sixth element. In this manner, a particularly high level of performance can be achieved at relatively moderate costs with only three planetary gears that mesh differently.

In a further development of the invention, it has proved advantageous when first planetary gears are rotatably mounted, i.e., arranged, in particular positioned, on the second element. The first planetary gears permanently mesh with a first toothing of the first element. In each case, one of the first planetary gears meshes, in particular permanently, with one of the respective second planetary gears. The second planetary gears permanently mesh with a fourth toothing of the fourth element. In this manner, a particularly high-performance electric drive system can be realized.

A further development of the invention provides that the second planetary gears are designed as stepped planetary gears, wherein the second planetary gears each have a first stepped gear axially overlapping the first element and a second stepped gear axially overlapping the fourth element, wherein in each case one of the first stepped gears and one of the second stepped gears are connected to each other in a rotationally fixed manner, wherein in each case one of the second stepped gears meshes with one of the third planetary gears. The term “stepped planetary gear” therefore refers to a planetary gear that has two different toothings with different tooth diameters. The term “stepped gear” here refers to a gear wheel representing a part of the stepped planetary gear. The stepped planetary gear has two stepped gears that are each arranged coaxially to each other and are each connected in a rotationally fixed manner to each other. In each case, the two stepped gears of a stepped planetary gear are rotatably arranged on a common planetary gear bolt. With the aid of the stepped planetary gears, a very compact coupling gear mechanism can be realized, especially with respect to the axial direction.

In the development with the stepped planetary gears, it is particularly advantageous if the second stepped gears permanently mesh with the fourth element, wherein first planetary gears are rotatably mounted on the second element, wherein the first planetary gears permanently mesh with a first toothing of the first element, wherein in each case one of the first planetary gears meshes with one of the first stepped gears.

Alternatively, the development with the stepped planetary gears can be further improved if the third planetary gears mesh with both the fourth element and the sixth element, in which case the first stepped gears advantageously mesh with both the first element and the third element.

In a further, particularly advantageous embodiment of the invention, a first transmission stage is provided, which is arranged downstream of the first output drive shaft and downstream of the coupling gear mechanism and in particular upstream of a first of the vehicle wheels with respect to a first torque flow, wherein, for example, the respective first output drive torque can be transmitted along the first torque flow from the coupling gear mechanism and the first output drive shaft via the first transmission stage to or onto the first vehicle wheel, so that the first transmission stage is arranged in the first torque flow and thereby downstream of the first output drive shaft and upstream of the first vehicle wheel. Furthermore, a second transmission stage is preferably provided, which is arranged downstream of the second output drive shaft and downstream of the coupling gear mechanism and in particular upstream of the second vehicle wheel with respect to a second torque flow, wherein the respective second output drive torque can be transmitted from the coupling gear mechanism and the second output drive shaft to the second vehicle wheel via the second transmission stage along the second torque flow, for example. Thus, the second transmission stage is arranged in the second torque flow and thus upstream of the second vehicle wheel and downstream of the second output drive shaft. This allows a particularly efficient drive of the vehicle wheels to be realized in a particularly space-efficient manner.

In order to be able to realize a particularly advantageous drive in a particularly space-efficient manner, it is provided in a further embodiment of the invention that the first element is the first sun gear, the third element is the first ring gear, the fourth element is the second sun gear, and the sixth element is the second ring gear.

In order to be able to realize particularly efficient operation and a particularly low installation space requirement of the electric drive system, a further very advantageous development provides that the electric drive system has a first switching element, which is provided or designed to couple the first rotor to the fourth element, in particular in a torque-transmitting and most particularly in a rotationally fixed manner, in such a way that the first drive torques, which are provided or can be provided by the first electric engine via the first rotor, can be introduced into the coupling gear mechanism at the fourth element, i.e., via the fourth element. In other words, the first switching element is provided or designed to couple the first rotor to the fourth element, in particular in a torque-transmitting or rotationally fixed manner, in such a way that the first drive torques, originating from the first electric engine or from the first rotor, can be introduced into the coupling gear mechanism at the fourth element or via the fourth element.

According to a further development, a second switching element is also provided, which is designed or provided to couple the first rotor to the second element, in particular in a torque-transmitting and most particularly in a rotationally fixed manner, in such a way that the first drive torques, which are provided or can be provided by the first electric engine via the first rotor, can be introduced into the coupling gear mechanism at the second element, i.e., via the second element. In other words, the second switching element is provided or designed to couple the first rotor to the second element, in particular in a torque-transmitting and most particularly in a rotationally fixed manner, that the first drive torques, originating from the first electric engine or from the first rotor, can be introduced into the coupling gear mechanism at the second element or via the second element.

Furthermore, the electric drive system advantageously also comprises a third switching element, which is designed or provided to couple the second rotor to the first element, in particular in a torque-transmitting and most particularly in a rotationally fixed manner, in such a way that the second drive torques, which are provided or can be provided by the second electric engine via the second rotor, can be introduced into the coupling gear mechanism at the first element. In other words, the third switching element is designed to couple the second rotor to the first element, in particular in a torque-transmitting and most particularly in a rotationally fixed manner, in such a way that the second drive torques, originating from the second electric engine or from the second rotor, can be introduced into the coupling gear mechanism at the first element or via the first element.

By means of the switching elements, different operating modes can be realized, so that on the one hand a very energy-saving operating mode can be used and on the other hand various performance operating modes can be used.

For example, the first switching element can be switched between a first coupled state and a second coupled state. In the first coupled state, the first rotor is coupled to the fourth element by means of the first switching element in a torque-transmitting manner, particularly advantageously in a rotationally fixed manner. In the first decoupled state, the first rotor is decoupled from the fourth element, so that no torques can be transmitted via the first switching element between the first rotor and the fourth element. For example, the first switching element can be moved, in particular translationally and/or relative to the housing, between at least one first coupled position, which brings about the first coupled state, and at least one first decoupled position, which brings about the first decoupled state.

For example, the second switching element can be switched between a second coupled state and a second decoupled state. In the second coupled state, the first rotor is coupled, i.e., connected, to the second element by means of the second switching element in a torque-transmitting manner, particularly advantageously in a rotationally fixed manner, so that the respective first drive torque can be transmitted from the first rotor via the second switching element to the second element. As a result, in the first coupled state, for example, the respective first drive torque can be transmitted from the first rotor onto or to the fourth element via the first switching element. In the second decoupled state, the first rotor is decoupled from the second element, so that no torques can be transmitted via the second switching element between the first rotor and the fourth element. In particular, for example, the second switching element can be moved, in particular translationally and/or relative to the housing, between at least one second coupled position, which brings about the second coupled state, and at least one second decoupled position, which brings about the second decoupled state.

The third switching element can be switched between a third coupled state and a third decoupled state, for example. In the third coupled state, the second rotor is coupled to the first element by means of the third switching element in a torque-transmitting, in particular rotationally fixed, manner, so that the respective second drive torque can be transmitted from the second rotor to or onto the first element via the third switching element. In the third decoupled state, for example, the second rotor is decoupled from the first element, so that no torques can be transmitted via the third switching element between the second rotor and the first element. For example, the third switching element can be moved, in particular translationally and/or relative to the housing, between at least one third coupled position, which brings about the third coupled state, and at least one third decoupled position, which brings about the third decoupled state.

In order to realize particularly efficient operation, the third switching element is preferably designed as a form-fit switching element, in particular as a claw coupling, so that, for example, in the third coupled state, the second rotor is form-fittingly coupled, i.e., connected, to the first element in a torque-transmitting, in particular rotationally fixed, manner by means of the third switching element.

In the scope of the entire present disclosure, ordinal numbers also referred to as ordinals, such as for example “first”, “second” etc. are not necessarily used in order to specify or imply a number or amount, but rather to be able to make clear reference to terms, to which the ordinal numbers are assigned or to which the ordinal numbers refer.

A further embodiment is characterized in that the first switching element is designed to couple the first rotor in a rotationally fixed manner to the fourth element. As a result, the weight and installation space requirements of the drive system can be kept particularly low and particularly efficient operation can be realized.

In a further, particularly advantageous embodiment of the invention, the second switching element is designed to couple the first rotor in a rotationally fixed manner to the second element. This further reduces the weight and installation space requirements of the drive system and minimizes losses.

In a further, particularly advantageous embodiment of the invention it is provided that the third switching element is designed to couple the second rotor in a rotationally fixed manner to the first element. This makes it possible to achieve particularly efficient operation while minimizing installation space and weight.

A second aspect of the invention relates to a method for operating an electric drive system according to the first aspect of the invention. Advantages and advantageous embodiments of the first aspect of the invention are to be regarded as advantages and advantageous embodiments of the second aspect of the invention and vice versa.

To realize particularly efficient operation, it has proven to be advantageous if the first switching element is closed, the second switching element is open and the third switching element is closed for a torque shift mode of the drive system.

In order to be able to realize particularly efficient operation, it is provided in a further embodiment of the invention that for an efficiency mode of the drive system, the first switching element is open, the second switching element is closed and the third switching element is open.

For a second torque shift mode of the drive system, the second switching element is closed, the first switching element is open and the third switching element is closed, for example. During or in the first torque shift mode, for example, both electric engines, i.e., both rotors, drive the motor vehicle, in particular the vehicle wheels, in particular simultaneously, wherein a distribution of the drive torques that are or can be provided by the electric engines via their rotors to the two vehicle wheels depends on a torque ratio of the two electric engines with respect to one another. This means, for example, that more torque, i.e., a greater torque, can be transmitted to one of the vehicle wheels than one of the two electric engines can provide at most. During or in the second torque shift mode, for example, only one of the electric engines, in particular the first electric engine, drives the motor vehicle, in particular the vehicle wheels, in relation to the electric machines, with the drive torque provided by the one electric engine being distributed to the two vehicle wheels by corresponding operation of the other electric engine, in particular the second electric engine; consequently, a distribution of the drive torque provided by the one electric engine, in particular by the rotor of the one electric engine, to the vehicle wheels can be adjusted, i.e., varied, by operating the other electric engine, in particular correspondingly. In the second torque shift mode, the other electric engine therefore has no significant share of torque to drive the motor vehicle. The respective vehicle wheel can receive significantly more than 50 per cent of the drive torque provided by the one electric engine via the rotor of the one electric engine. For this purpose, the second electric engine drives very gently or brakes very gently. The second torque shift mode is advantageous, for example, when cornering in the efficiency operating mode, also referred to as efficiency mode, and when a torque shift is then to be achieved, in particular simply by engaging, i.e., closing, the third switching element.

It can be seen that in torque shift mode, such a torque shift or torque distribution can be realized in such a way that a distribution or division of the drive torque that can be provided or is provided by the one electric engine via the rotor of the one electric engine to the vehicle wheels can be varied, i.e., adjusted, by operating the other electric engine, in particular by the other electric engine either driving or braking the coupling gear mechanism. For example, the coupling gear mechanism has a basic distribution, according to which, for example, a total torque introduced into the coupling gear mechanism is divided or distributed to the output drive shafts, and via these to the vehicle wheels. In particular, the basic distribution is defined, i.e., specified, by a mechanical construction of the coupling gear mechanism. The total torque results, for example, from the respective, first drive torque and/or from the respective, second drive torque, wherein, for example, the total torque can then in particular result from the respective, first drive torque and from the respective, second drive torque, when the second rotor provides the respective second drive torque and, in particular simultaneously, the first rotor provides the respective first drive torque and the first drive torque and the second drive torque are introduced into the coupling gear mechanism, in particular simultaneously. By operating the other electric machine, i.e., because the other electric machine drives the coupling gear mechanism, i.e., for example at least one of the gear elements and/or at least one of the components, and/or because the other electric engine brakes the coupling gear mechanism, i.e., the at least one gear element and/or the at least one component, the coupling gear mechanism can be influenced in such a way that, for example, the respective drive torque provided by the one electric engine or the total torque is not or not only distributed or divided to the output drive shafts and via these to the vehicle wheels according to the basic distribution, but according to a distribution that differs from the basic distribution, wherein the distribution can be varied, for example by varying the operation of the other electric engine, that is, for example, by varying a torque provided by the other electric engine, in particular by the rotor of the other electric engine, for driving or braking the coupling gear mechanism. This allows, for example, the respective first output drive torque to be set to a first value, in particular a first amount, and the second output drive torque to be set, in particular simultaneously, to a second value that differs from the first value, in particular a second amount that differs from the first amount. This torque shift is particularly advantageous when the motor vehicle is cornering, as a greater torque can then be allocated to the vehicle wheel on the outside of the bend than to the vehicle wheel on the inside of the bend, in order to advantageously accelerate the motor vehicle out of a bend, for example. Therefore, particularly advantageous driving dynamics can be achieved. Thus, the invention enables the realization of a particularly high level of performance, in particular with regard to high lateral dynamics, in particular with simultaneously high efficiency of the drive system. Furthermore, the invention enables a particularly compact construction of the drive system.

In efficiency operating mode, also known as efficiency mode, with regard to the electric engines, only one of the electric engines, in particular the first electric engine, drives the motor vehicle, in particular while the other electric engine is not operating, i.e., while the other electric engine neither drives nor brakes the coupling gear mechanism. In this case, for example, the coupling gear mechanism balances like a conventional differential gearbox, and the drive torque provided by the one electric engine, in particular via the rotor of the electric engine, is divided or distributed to the output drive shafts and via these to the vehicle wheels in accordance with the basic distribution, which is for example 50:50. Despite the basic distribution, which is, for example, a 50:50 distribution, the vehicle wheels can achieve or have different speeds, especially when cornering, but in particular not different torques, since, for example, the coupling gear mechanism can be operated or is designed like a conventional differential gearbox, also known as a differential or axle drive, which allows different speeds of the vehicle wheels, especially when cornering, while the vehicle wheels are driven or can be driven by the one electric engine, i.e., are coupled to the rotor of the one electric engine in a torque-transmitting manner.

Further advantages, features and details of the invention can be seen from the following description of preferred exemplary embodiments and from the drawing. In the drawing, identical or functionally identical components are labelled with the same reference signs.

### BRIEF DESCRIPTION OF THE DRAWING FIGURES

The drawing shows in:

FIG. 1 a schematic representation of a basic form of an electric drive system for a motor vehicle;

FIG. 2 a detailed schematic representation of a first embodiment of the electric drive system;

FIG. 3 a switch table for illustrating different operations, also referred to as modes or operating modes, of the electric drive system;

FIG. 4 a schematic representation of a second embodiment of the electric drive system;

FIG. 5 a schematic representation of a third embodiment of the electric drive system

FIG. 6 a schematic representation of a fourth embodiment of the electric drive system.

In the figures, identical or functionally identical elements are provided with the same reference signs.

### DETAILED DESCRIPTION

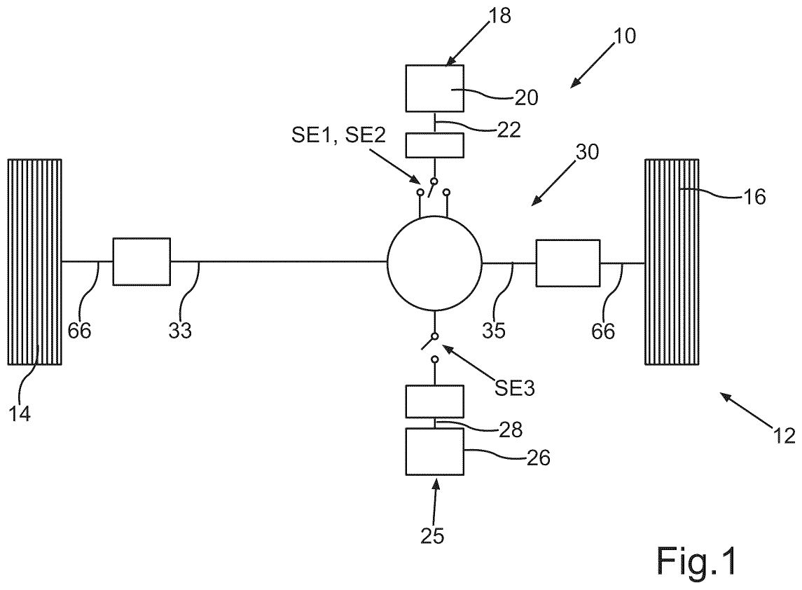

FIG. 1 shows in a schematic representation an electric drive system 10 for a motor vehicle, also simply referred to as a vehicle, which is preferably designed as a motor vehicle, more particularly as a passenger car. The motor vehicle, in its completely produced state, has at least or exactly two vehicle axles, also simply referred to as axles, arranged successively and thus one behind the other in the vehicle longitudinal direction. One of the vehicle axles can be seen in FIG. 1 and is labelled with 12. The respective vehicle axle has at least or exactly two vehicle wheels, also simply referred to as wheels, specifically a first vehicle wheel 14 and a second vehicle wheel 16. It can be seen that the vehicle wheels 14 and 16 are arranged on opposites sides of the motor vehicle to each other in the vehicle transverse direction.

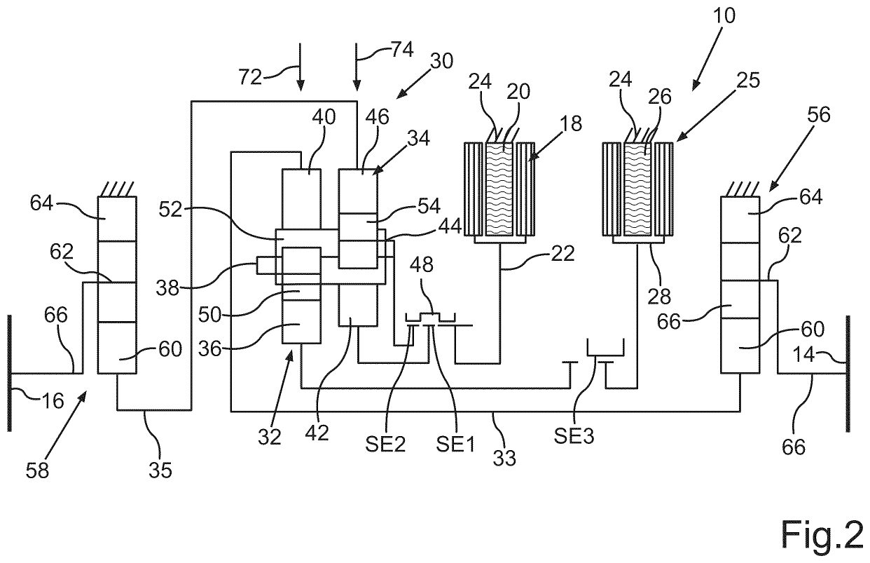

By means of the drive system 10, the vehicle wheels 14 and 16 and the motor vehicle as a whole can be driven electrically, in particular purely electrically. The vehicle wheels 14 and 16 are ground contact elements via which the motor vehicle is or can be supported downwards on the ground in the vertical direction of the vehicle. If the motor vehicle drives along the ground while it is supported downwards on the ground via the ground contact elements in the vertical direction of the vehicle, the vehicle wheels 14 and 16 roll, in particular directly, along the ground. For this purpose, the electric drive system 10 has a first electric engine 18 having a first stator 20 and a first rotor 22. The first rotor 22 can be driven by means of the stator 20 and thus can be rotated around an engine rotational axis, relative to the stator 20 and relative to a housing 24, shown particularly schematically in FIG. 2, of the drive system 10. The electric engine 18 can provide respective first drive torques via its first rotor 22 to drive the vehicle wheels 14 and 16 of the motor vehicle. The electric drive system 10 furthermore comprises a second electric engine 25 having a second stator 26 and a second rotor 28. The second rotor 28 can be driven by means of the second stator 26 and thus can be rotated around a second engine rotational axis, relative to the second stator 26 and relative to the housing 24. The second electric engine 25 can provide respective second drive torques via its second rotor 28 to drive the vehicle wheels 14 and 16 and thus the motor vehicle.

The drive system 10 furthermore comprises a coupling gear mechanism 30, which can have a central superimposing unit or can be designed as a central superimposing unit. The coupling gear mechanism 30 has a first output drive shaft 33 and a second output drive shaft 35. First output drive torques can be discharged from the coupling gear mechanism 30 via the first output drive shaft 33, so that the coupling gear mechanism 30 can provide the first output drive torques via the first output drive shaft 33. Second output drive torques can be discharged via the second output drive shaft 35 from the coupling gear mechanism 30, which can thus provide the second output drive torques via the second output drive shaft 35. For example, the respective first output drive torque results from the respective first drive torque and/or from the respective second drive torque, and the respective second output drive torque results, for example, from the respective first drive torque and/or from the respective second drive torque. It can be seen that the first vehicle wheel 14 can be driven by the first output drive shaft 33 and thus by the coupling gear mechanism 30 via the first output drive shaft 33 and by the respective electric engine 18, 25 via said coupling gear mechanism. Accordingly, the second vehicle wheel 16 can be driven by the second output drive shaft 35 and thus by the coupling gear mechanism 30 via the second output drive shaft 35 and by the respective electric engine 18, 25 via said coupling gear mechanism.

Advantageously, it is provided that the first rotor 22 can be coupled, in particular connected in a rotationally fixed manner, to a first shaft of the coupling gear mechanism 30 by means of a first switching element SE1, and that the first rotor 22 can be coupled, in particular connected in a rotationally fixed manner, to a second shaft of the coupling gear mechanism 30 by means of a second switching element SE2. The second rotor 28 can advantageously be connected to a third shaft of the coupling gear mechanism 30, in particular connected in a rotationally fixed manner.

In connection with FIG. 2, it can be seen that the coupling gear mechanism 30, in particular the superimposing unit, has a first planetary gear set 32 and a second planetary gear set 34. The first planetary gear set 32 has a first element 36, a second element 38, and a third element 40, and the second planetary gear set 34 has a fourth element 42, a fifth element 44, and a sixth element 46. In the embodiments shown in the figures, the first element 36 is a first sun gear, the second element 38 is a first planetary carrier, which is also referred to as a first bridge, and the third element 40 is a first ring gear. The fourth element 42 is a second sun gear, the fifth element 44 is a second planetary carrier, which is also referred to as a second bridge, and the sixth element 46 is a second ring gear. It can be seen that the third element 40 is connected, in particular permanently, in a rotationally fixed manner to the first output drive shaft 33. Furthermore, the fifth element 44 is connected, in particular permanently, in a rotationally fixed manner to the second element 38. Furthermore, the sixth element 46 is connected, i.e., coupled, in particular permanently, in a rotationally fixed manner to the second output drive shaft 35.

The coupling gear mechanism 30 thus has planetary carriers connected to each other in a rotationally fixed manner, which form a common planetary carrier. The common planetary carrier (i.e., the second element 38 and the fifth element 44 connected in a rotationally fixed manner to the second element 38) together with the third element 40 and the sixth element 46 forms a sub-transmission of the coupling gear mechanism 30. This sub-transmission can be understood as a differential gearbox, in which the common planetary carrier functions as a differential input shaft and in which the third element 40 and the sixth element 46 each function as differential output shafts.

In order to be able to realize a particularly efficient operation and a particularly compact design of the drive system 10, the drive system 10 has the first switching element SE1, by means of which the first rotor 22 can be coupled, i.e., connected, to the fourth element 42 in a torque-transmitting manner, in particular in a rotationally fixed manner, so that the respective first drive torque that is provided or can be provided by the first electric engine 18 via its first rotor 22, can be introduced into the coupling gear mechanism 30 at or via the fourth element 42. The fourth element 42 comprises the first shaft of the coupling gear mechanism 30, mentioned in connection with FIG. 1.

The electric drive system 10 also comprises the second switching element SE2, by means of which the first rotor 22 can be coupled, i.e., connected, to the second element 38 and thus to the fifth element 44 in a torque-transmitting, in particular rotationally fixed, manner, so that the respective first drive torque that can be provided or is provided by the first electric engine 18 via its first rotor 22 can be introduced into the coupling gear mechanism 30 at or via the second element 38, wherein the second element 38 comprises the second shaft of the coupling gear mechanism 30 mentioned in connection with FIG. 1. For this purpose, a switching part 48 is provided, for example in the form of a sliding sleeve, which can be switched between a first state and a second state. In particular, the switching part 48 can be moved, in particular relative to the housing 24 and/or translationally, between at least one first position bringing about the first state and at least one second position bringing about the second state. The first state is a first coupled state, and the second state is a second coupled state that is accompanied by a first decoupled state, while the first coupled state is accompanied by a second decoupled state.

In the basic form and in the first embodiment, in the first state, and thus in the first coupled state, the first rotor 22 is connected, in particular with a form fit, by means of the switching part 48 and by means of the switching element SE1 to the fourth element 42 in a torque-transmitting, in particular rotationally fixed, manner, in particular while the first rotor 22 is decoupled from the second element 38, such that no torques can be transmitted between the first rotor 22 and the second element 38 via the first switching element SE1. In the second state, the first rotor 22 is coupled in a torque-transmitting, in particular rotationally fixed, manner to the second element 38 by means of the second switching element SE2 and by means of the switching part 48, in particular while the first rotor 22 is decoupled from the fourth element 42, in such a way that no torques can be transmitted between the first rotor 22 and the fourth element 42 via the second switching element SE2.

Therefore, the first coupled state is accompanied by the second decoupled state and the second coupled state is accompanied by the first decoupled state, so that the first state corresponds to the first coupled state and the second decoupled state, and the second state corresponds to the second coupled state and the first decoupled state.

The electric drive system 10 also comprises the third switching element SE3, by means of which the second rotor 28 can be coupled, in particular connected, to the first element 36 in a torque-transmitting manner, in particular in a rotationally fixed manner, so that the respective second drive torque, which is provided or can be provided by the second electric engine 25 via the second rotor 28, can be introduced into the coupling gear mechanism 30 at or via the first element 36. The first element 36 comprises the third shaft of the coupling gear mechanism 30, mentioned in connection with FIG. 1.

In the detailed first embodiment, shown in FIG. 2, first planetary gears 50 and second planetary gears 52 are rotatably arranged, i.e., mounted, on the second element 38, wherein the first planetary gears 50 mesh permanently with first toothing of the first element 36. The second planetary gears 52 mesh permanently with a third toothing of the third element 40 and in each case one of the first planetary gears 50 meshes, in particular permanently, with a respective one of the second planetary gears 52. The second planetary gears 52 and in particular third planetary gears 54, provided in addition thereto, are rotatably arranged, i.e., mounted, on the fifth element 44, wherein the second planetary gears 52 permanently mesh with a fourth toothing of the fourth element 42. The third planetary gears 54 permanently mesh with a sixth toothing of the sixth element 46. In particular, there is no meshing of the planetary gears 50 with the element 40, and in particular there is no meshing of the planetary gears 52 with the element 46. In each case, one of the second planetary gears 52 meshes, in particular permanently, with one of the respective third planetary gears 54.

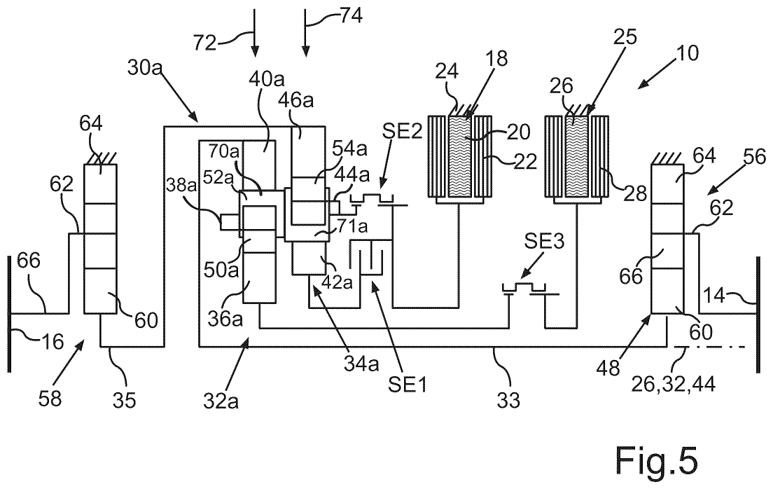

In the embodiment of FIG. 2, the second planetary gears are designed with a uniform tooth diameter. Preferably, the second planetary gears 52 are designed as stepped planetary gears, this being described in more detail in FIG. 5 in particular.

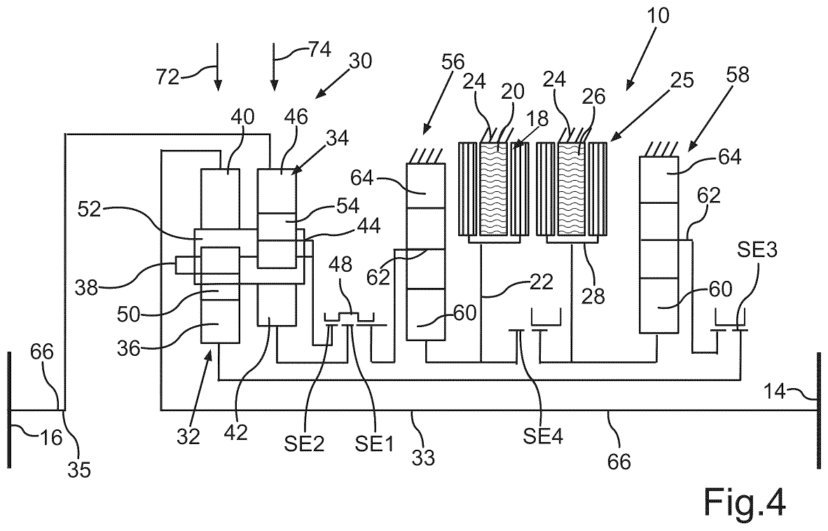

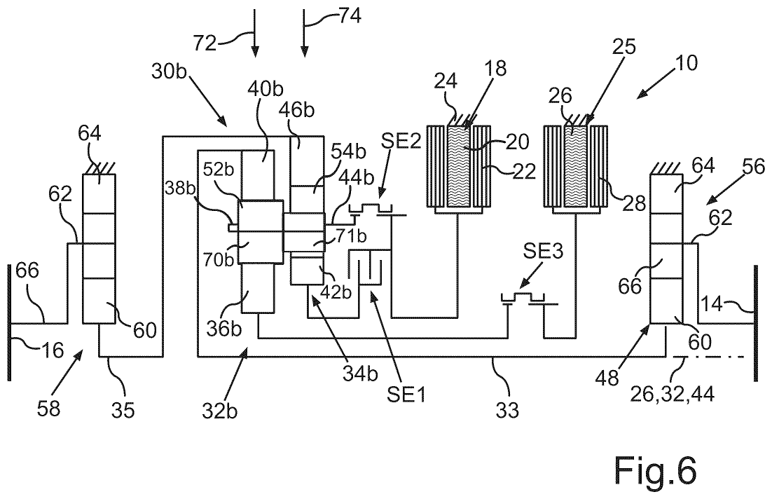

In the embodiments in FIG. 2, FIG. 4, FIG. 5, and FIG. 6, the coupling gear mechanism 30 has two toothing planes in each case, specifically a first toothing plane 72 and a second toothing plane 74. The first toothing plane 72 is arranged perpendicular to a rotational axis of the two planetary gear sets 32, 34, and lies axially in the region of a toothing of the first element 36. The second toothing plane 74 is similarly arranged perpendicular to the rotational axis of the planetary gear sets and lies axially in the region of a toothing of the fourth element 42. All of the toothing engagements of the first planetary gear set 32 are intersected by the first toothing plane 72. All of the toothing engagements of the second planetary gear set 34 are intersected by the second toothing plane 74. There are no further toothing engagements of the coupling gear mechanism 30 that are not intersected by either the first toothing plane 72 or the second toothing plane 74.

As is shown schematically in all of the embodiments of FIG. 2, FIG. 4, FIG. 5, and FIG. 6, the respective electric engines 18, 25 are preferably designed as axial flux machines (AFM). Here, for example, the respective rotor 22, 28 comprises two rotor elements, also referred to as rotor discs, which are spaced apart from each other in the axial direction of the respective electrical engine 18, 25, wherein the respective stator 20, 26 is arranged in the axial direction of the respective electrical engine 18, 25 between the respective stator elements. The entire electric drive system can made particularly compact and to deliver high performance, although two electric engines each require a large amount installation space and are costly to operate.

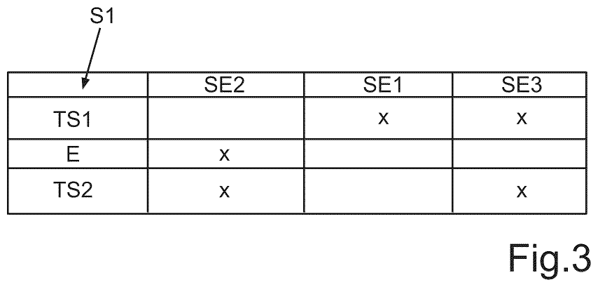

FIG. 3 shows a switch table having a column S1 in which three operating modes, also referred to as operations, have been entered. The respective operating mode is also referred to as an operating state. A first of the operating modes is a first torque shift mode TS1, a second of the operating modes is an efficiency operating mode E, also referred to as efficiency mode, and a third of the operating modes is a second torque shift mode TS2. As can be seen from the switch table, the switching element SE1 is closed for the or in the first torque shift mode, while the switching element SE3 is closed, the switching element SE2 is open, i.e., opened. For the or in the efficiency mode E, the switching elements SE1 and SE3 are opened, in particular simultaneously, while the switching element SE2 is closed. For the or in the second torque shift mode TS2, the switching elements SE2 and SE3 are closed, in particular simultaneously, while the switching element SE1 is opened, i.e., open.

The feature that the switching element SE1 is closed means that the element 42 is connected to the rotor 22 by means of the switching element SE1 in a torque-transmitting, i.e., rotationally fixed, manner, meaning that the switching element SE1 is in the first coupled state. The feature that the switching element SE2 is closed means that the rotor 22 is connected to the second element 38 by means of the switching element SE2 in a torque-transmitting, in particular rotationally fixed, manner, meaning that the switching element SE2 is in the second coupled state. The feature that the switching element SE3 is closed means that the rotor 28 is connected to the element 36 by means of the switching element SE3 in a torque-transmitting, in particular rotationally fixed, manner, meaning that the switching element SE3 is in its third coupled state. The feature that the switching element SE3 is open means that the switching element SE3 is in its third decoupled state, in which no torques can be transmitted via the switching element SE3 between the rotor 28 and the element 36. The feature that the switching element SE1 is open means that the switching element SE1 is in its first decoupled state, in which no torques can be transmitted via the switching element SE1 between the rotor 22 and the element 42. The feature that the switching element SE2 is open or opened means that the switching element SE2 is in its second decoupled state, in which no torques can be transmitted via the switching element SE2 between the rotor 22 and the second element 38.

FIG. 4 shows a schematic representation of a second embodiment of the electric drive system 10, wherein the second embodiment differs from the first embodiment only in regard to two aspects, specifically first in that the transmission stages 56, 58 are not arranged after but before the coupling gear mechanism 30, and secondly in that a fourth switching element SE4 is provided.

In the second embodiment, the first transmission stage 56 is arranged between the first rotor 22 and the coupling gear mechanism 30, with respect to a torque originating from the first electric engine 18. In the second embodiment, the first transmission stage 56 is arranged between the first rotor 22 and the first switching element SE1 as well as between the first rotor 22 and the second switching element SE2, with respect to a torque originating from the first electric engine 18.

In the second embodiment, the second transmission stage 58 is arranged between the second rotor 28 and the coupling gear mechanism 30, with respect to a torque originating from the second electric engine 25.

In the second embodiment, the second transmission stage 58 is arranged between the second rotor 28 and the third switching element, with respect to a torque originating from the second electric engine 25. Alternatively, and not shown in the drawings, the third switching element SE3 can be arranged between the second rotor 28 and the second transmission stage with respect to the torque originating from the second electric engine 25, in which case the coupling gear mechanism 30 follows immediately after the second transmission stage 58, for example by the eighth element 62 of the second transmission stage 58 being connected in a rotationally fixed manner to the first element 36.

The arrangement of the transmission stages 56, 58, as shown in FIG. 4, can also be applied to the first embodiment.

In the second embodiment, the electric drive system 10 has a fourth switching element SE4. The fourth switching element SE4 is designed to connect the first rotor 22 in a rotationally fixed manner to the second rotor 28.

A boost mode can be realized by means of the fourth switching element SE4 by closing the second switching element SE2, opening the first switching element SE1, opening the third switching element SE3 and closing the fourth switching element SE4.

The drive system 10 of the third embodiment, shown in FIG. 5, comprises a coupling gear mechanism 30a having a central superimposing unit. In the following, the differences to the first embodiment will be discussed in particular.

The coupling gear mechanism 30a has a first planetary gear set 32a and a second planetary gear set 34a. The first planetary gear set 32a has a first element 36a, a second element 38a, and a third element 40a, and the second planetary gear set 34a has a fourth element 42a, a fifth element 44a, and a sixth element 46a. Here as well, the first element 36a is a first sun gear, the second element 38a is a first planetary carrier, which is also referred to as a first bridge, and the third element 40a is a first ring gear. The fourth element 42a is a second sun gear, the fifth element 44a is a second planetary carrier, which is also referred to as a second bridge, and the sixth element 46a is a second ring gear. It can be seen that the third element 40a is connected, in particular permanently, in a rotationally fixed manner to the first output drive shaft 33. Furthermore, the fifth element 44a is connected, in particular permanently, in a rotationally fixed manner to the second element 38a. Furthermore, the sixth element 46a is connected, in particular permanently, in a rotationally fixed manner to the second output drive shaft 35.

The coupling gear mechanism 30a thus has planetary carriers connected to each other in a rotationally fixed manner, which form a common planetary carrier. The common planetary carrier (i.e., the second element 38a and the fifth element 44a connected in a rotationally fixed manner to the second element 38a) together with the third element 40a and the sixth element 46a forms a sub-transmission of the coupling gear mechanism 30a. This sub-transmission can be understood as a differential gearbox, in which the common planetary carrier functions as a differential input shaft and in which the third element 40a and the sixth element 46a each function as differential output shafts.

In the third embodiment, shown in FIG. 5, first planetary gears 50a and second planetary gears 52a are rotatably arranged, i.e., mounted, on the second element 38a, wherein the first planetary gears 50a mesh permanently with a first toothing of the first element 36a. The second planetary gears 52a mesh permanently with a third toothing of the third element 40a and in each case with one of the first planetary gears 50a meshes, in particular permanently with a respective one of the second planetary gears 52a. The first toothing plane also intersects all of the toothing engagements of the first planetary gear set 32a.

The second planetary gears 52a and in particular third planetary gears 54a, provided in addition thereto, are rotatably arranged, i.e., mounted, on the fifth element 44a, wherein the second planetary gears 52a permanently mesh with a fourth toothing of the fourth element 42a. The third planetary gears 54a permanently mesh with a sixth toothing of the sixth element 46a. In particular, there is no meshing of the first planetary gears 50a with the third element 40a, and in particular there is no meshing of the second planetary gears 52a with the sixth element 46a. In each case, one of the second planetary gears 52a meshes, in particular permanently, with one of the respective third planetary gears 54a.

A significant difference between the third embodiment of FIG. 5 and the first embodiment of FIG. 2 is that the second planetary gears 52a are designed as stepped planetary gears. Each of the stepped planetary gears 52a has a first stepped gear 70a and a second stepped gear 71a. In each case, a first stepped gear 70a is connected in a rotationally fixed manner to a second stepped gear 71a and is arranged on a common planetary gear bolt. The second stepped gears 71a advantageously have a larger diameter than the first stepped gears 70a. The first stepped gears 70a are assigned to the first planetary gear set 32a and are intersected by the first toothing plane 72. The second stepped gears 71a are assigned to the second planetary gear set 34a and are intersected by the second toothing plane 74.

The drive system 10 of the fourth embodiment, shown in FIG. 6, comprises a coupling gear mechanism 30b which has a central superimposing unit. In the following, the differences to the first embodiment will be discussed in particular.

The coupling gear mechanism 30b has a first planetary gear set 32b and a second planetary gear set 34b. The first planetary gear set 32b has a first element 36b, a second element 38b, and a third element 40b, and the second planetary gear set 34b has a fourth element 42b, a fifth element 44b, and a sixth element 46b. Here as well, the first element 36b is a first sun gear, the second element 38b is a first planetary carrier, which is also referred to as a first bridge, and the third element 40b is a first ring gear. The fourth element 42b is a second sun gear, the fifth element 44b is a second planetary carrier, which is also referred to as a second bridge, and the sixth element 46b is a second ring gear. It can be seen that the third element 40b is connected, in particular permanently, in a rotationally fixed manner to the first output drive shaft 33. Furthermore, the fifth element 44b is connected, in particular permanently, in a rotationally fixed manner to the second element 38b. Furthermore, the sixth element 46b is connected, in particular permanently, in a rotationally fixed manner to the second output drive shaft 35.

The coupling gear mechanism 30b thus also has planetary carriers connected to each other in a rotationally fixed manner, which form a common planetary carrier. The common planetary carrier (i.e., the second element 38b and the fifth element 44b connected in a rotationally fixed manner to the second element 38b) together with the third element 40b and the sixth element 46b forms a sub-transmission of the coupling gear mechanism 30b. This sub-transmission can be understood as a differential gearbox, in which the common planetary carrier functions as a differential input shaft and in which the third element 40b and the sixth element 46b each function as differential output shafts.

In the fourth embodiment shown in FIG. 6, second planetary gears 52b are rotatably arranged, i.e., mounted, on the second element 38b, wherein these second planetary gears 52b—unlike in the previous embodiments—mesh permanently with a first toothing of the first element 36b and also mesh permanently with a third toothing of the third element 40b. The first toothing plane 72 also intersects all of the toothing engagements of the first planetary gear set 32b.

The second planetary gears 52b and in particular third planetary gears 54b, provided in addition thereto, are rotatably arranged, i.e., mounted, on the fifth element 44a. The third planetary gears 54b mesh permanently with a sixth toothing of the sixth element 46b, and the third planetary gears 54b mesh permanently with a fourth toothing of the fourth element 42b. There is no meshing of the second planetary gears 52b with the fourth element 42, and there is no meshing of the second planetary gears 52b with the sixth element 46b. In each case, one of the second planetary gears 52b meshes, in particular permanently, with one of the respective third planetary gears 54b. The second toothing plane 74 also intersects all of the toothing engagements of the second planetary gear set 34b.

In the fourth embodiment of FIG. 6, the second planetary gears 52b are designed as stepped planetary gears. Each of the stepped planetary gears 52b has a first stepped gear 70b and a second stepped gear 71b. In each case, a first stepped gear 70b is connected in a rotationally fixed manner to a second stepped gear 71b and is arranged on a common planetary gear bolt. The second stepped gears 71b advantageously have a smaller diameter than the first stepped gears 70b. The first stepped gears 70b are assigned to the first planetary gear set 32b and are intersected by the first toothing plane 72. The second stepped gears 71b are assigned to the second planetary gear set 34b and are intersected by the second toothing plane 74.

Finally, reference should be made to two highly advantageous embodiments not shown in the figures.

In a fifth embodiment (not shown), the switching elements SE1, SE2, SE3, and SE4 are omitted, wherein in this fifth embodiment, as in the first torque shift mode TS1, the fourth element 42, 42a, 42b is coupled permanently in a torque-transmitting manner to the first rotor 22. Furthermore, in the fifth embodiment (not shown), the second rotor 28 is connected permanently in a torque-transmitting manner to the first element 36. The fifth embodiment thus results from the embodiments shown in each case in that the second switching element SE2 is omitted, in that the fourth switching element SE4, if present, is also omitted, in that a rotationally fixed connection is used in place of the first switching element SE1 (corresponding to a closed switching element SE1) and in that a rotationally fixed connection is used in place of the third switching element SE3. The fifth embodiment has significant weight and cost advantages but has the disadvantage that an efficiency mode in particular is not readily possible.

In a sixth embodiment, not shown, the switching elements SE1, SE2, SE3 and SE4 are also omitted, although unlike in the fifth embodiment, the first switching element SE1 is simply omitted without a closed connection being used in its place. And unlike in the fifth embodiment, the second switching element SE2 is replaced by a permanent torque-transmitting coupling of the first rotor 22 to the fifth element 44, 44a, 44b. Otherwise, the same applies to the omission of switching elements SE3, SE4 as in the description of the fifth embodiment. In the sixth embodiment, only the second torque shift mode TS2 is possible, since the shaft connections that replace the switching elements SE1, SE2, SE3, SE4 are the same as in the second torque shift mode TS2.

In the fifth embodiment and the sixth embodiment, the sub-transmission functioning as a differential gearbox (common planetary carrier consisting of second element 38 and fifth element 44, third element 40 and sixth element 46 as three shafts of a differential gearbox), it may be useful to design the gear diameters in such a way that a torque distribution to the differential output shafts (third element 40 and sixth element 46) is not produced in the usual ratio of 50:50, but for example in a ratio of 40:60. This can be particularly useful in terms of maximum engine power in an embodiment in which differently dimensioned electric engines are used.

### LIST OF REFERENCE SIGNS

10 electric drive system
12 vehicle axle
14 vehicle wheel
16 vehicle wheel
18 first electric engine
20 first stator
22 first rotor
24 housing
25 first electric engine
26 second stator
28 second rotor
30 coupling gear mechanism
32 first planetary gear set
33 first output drive shaft
34 second planetary gear set
35 second output drive shaft
36 first element
38 second element
40 third element
42 fourth element
44 fifth element
46 sixth element
48 switching part
50 first planetary gear
52 second planetary gear
54 third planetary gear
56 first transmission stage
58 second transmission stage
60 seventh element
62 eighth element
64 ninth element
66 further planetary gear
68 further shaft
70 first stepped gear
71 second stepped gear
72 first toothing plane
74 second toothing plane
E efficiency operating mode
SE1 first switching element
SE2 second switching element
SE3 third switching element
SE4 fourth switching element
TS1 first torque shift mode
TS2 second torque shift mode

1-15. (canceled)

16. An electric drive system for a motor vehicle having a first vehicle wheel and a second vehicle wheel, the electric drive system comprising:
a first electric engine with a first rotor;
a second electric engine with a second rotor;
a coupling gear mechanism having a first output drive shaft and a second output drive shaft, wherein the first and second output drive shafts are configured to discharge output drive torques from the coupling gear mechanism;
a first planetary gear set having a first element, a second element, and a third element, wherein the second element is a first planetary carrier and the third element is connected in a rotationally fixed manner to one of the first and second output drive shafts;
a second planetary gear set having a fourth element, a fifth element, and a sixth element, wherein the fifth element is connected in a rotationally fixed manner to the second element and is a second planetary carrier, and wherein the sixth element is connected in a rotationally fixed manner to the second output drive shaft,
wherein the first output drive shaft is coupled or is couplable in a torque-transmitting manner to the first vehicle wheel, bypassing the second element,
wherein the second output drive shaft is coupled or is couplable in a torque-transmitting manner to the second vehicle wheel, bypassing the second element,
wherein second planetary gears are mounted rotatably on the second element, wherein the second planetary gears permanently mesh with a third toothing of the third element,
wherein the second planetary gears and third planetary gears are rotatably mounted on the fifth element, wherein in each case one of the second planetary gears meshes with one of the third planetary gears, wherein the second planetary gears are arranged both axially overlapping the third element and axially overlapping the fourth element,
wherein the second planetary gears are stepped planetary gears, wherein the second planetary gears each have a first stepped gear axially overlapping the first element and a second stepped gear axially overlapping the fourth element, wherein in each case one of the first stepped gears and one of the second stepped gears are connected to each other in a rotationally fixed manner, wherein in each case one of the second stepped gears meshes with one of the third planetary gears, and
wherein the third planetary gears mesh with the fourth element and with the sixth element, wherein the first stepped gears mesh both with the first element and with the third element.

17. The electric drive system of claim 16, wherein the third planetary gears permanently mesh with a sixth toothing of the sixth element.

18. The electric drive system of claim 16, wherein
first planetary gears are rotatably mounted on the second element,
the first planetary gears permanently mesh with a first toothing of the first element,
in each case one of the first planetary gears meshes with one of the second planetary gears,
the second planetary gears permanently mesh with a fourth toothing of the fourth element.

19. The electric drive system of claim 16, wherein the second stepped gears permanently mesh with the fourth element, wherein first planetary gears are rotatably mounted on the second element, wherein the first planetary gears permanently mesh with a first toothing of the first element, wherein in each case one of the first planetary gears meshes with one of the first stepped gears.

20. The electric drive system of claim 16, further comprising:
a first transmission stage arranged downstream of the first output drive shaft and downstream of the coupling gear mechanism with respect to a torque flow, and
a second transmission stage arranged downstream of the second output drive shaft and downstream of the coupling gear mechanism with respect to the torque flow.

21. The electric drive system of claim 16, wherein the first element is a first sun gear, the third element is a first ring gear, the fourth element is a second sun gear, and the sixth element is a second ring gear.

22. The electric drive system of claim 16, further comprising:
a first switching element configured to couple the first rotor to the fourth element in such a way that first drive torques provided by the first electric engine via the first rotor are introduced into the coupling gear mechanism at the fourth element;
a second switching element configured to couple the first rotor to the second element in such a way that the first drive torques provided by the first electric engine via the first rotor are introduced into the coupling gear mechanism at the second element; and
a third switching element configured to couple the second rotor to the first element in such a way that second drive torques provided by the second electric engine via the second rotor are introduced into the coupling gear mechanism at the first element.

23. The electric drive system of claim 22, wherein the first switching element is configured to couple the first rotor in a rotationally fixed manner to the fourth element.

24. The electric drive system of claim 23, wherein the second switching element is configured to couple the first rotor in a rotationally fixed manner to the second element.

25. The electric drive system of claim 24, wherein the third switching element is configured to couple the second rotor in a rotationally fixed manner to the first element.

26. A method for operating the electric drive system for a motor vehicle having a first vehicle wheel and a second vehicle wheel, the electric drive system comprising a first electric engine with a first rotor, a second electric engine with a second rotor, a coupling gear mechanism having a first output drive shaft and a second output drive shaft, wherein the first and second output drive shafts are configured to discharge output drive torques from the coupling gear mechanism, a first planetary gear set having a first element, a second element, and a third element, wherein the second element is a first planetary carrier and the third element is connected in a rotationally fixed manner to one of the first and second output drive shafts, a second planetary gear set having a fourth element, a fifth element, and a sixth element, wherein the fifth element is connected in a rotationally fixed manner to the second element and is a second planetary carrier, and wherein the sixth element is connected in a rotationally fixed manner to the second output drive shaft, wherein the first output drive shaft is coupled or is couplable in a torque-transmitting manner to the first vehicle wheel, bypassing the second element, wherein the second output drive shaft is coupled or is couplable in a torque-transmitting manner to the second vehicle wheel, bypassing the second element, wherein second planetary gears are mounted rotatably on the second element, wherein the second planetary gears permanently mesh with a third toothing of the third element, wherein the second planetary gears and third planetary gears are rotatably mounted on the fifth element, wherein in each case one of the second planetary gears meshes with one of the third planetary gears, wherein the second planetary gears are arranged both axially overlapping the third element and axially overlapping the fourth element, wherein the second planetary gears are stepped planetary gears, wherein the second planetary gears each have a first stepped gear axially overlapping the first element and a second stepped gear axially overlapping the fourth element, wherein in each case one of the first stepped gears and one of the second stepped gears are connected to each other in a rotationally fixed manner, wherein in each case one of the second stepped gears meshes with one of the third planetary gears, and wherein the third planetary gears mesh with the fourth element and with the sixth element, wherein the first stepped gears mesh both with the first element and with the third element, and wherein the electric drive system further comprises a first switching element configured to couple the first rotor to the fourth element in such a way that first drive torques provided by the first electric engine via the first rotor are introduced into the coupling gear mechanism at the fourth element, a second switching element configured to couple the first rotor to the second element in such a way that the first drive torques provided by the first electric engine via the first rotor are introduced into the coupling gear mechanism at the second element, and a third switching element configured to couple the second rotor to the first element in such a way that second drive torques provided by the second electric engine via the second rotor are introduced into the coupling gear mechanism at the first element, wherein the method comprises:
implementing a torque shift mode of the electric drive system by closing the first switching element, opening the second switching element, and closing the third switching element.

27. The method of claim 26, further comprising:
implementing an efficiency mode of the electric drive system by opening the first switching element, closing the second switching element, and opening the third switching element.

28. The method of claim 26, further comprising:
implementing a further torque shift mode of the drive system by opening the first switching element, closing the second switching element, and closing the third switching element.
